(19) United States
(12) Patent Application Publication
(10) Pub. No.: US 2015/0221189 A1
(43) Pub. Date: Aug. 6, 2015

(54) DISCRIMINATION OBJECT AND MEDICAL DEVICE

(71) Applicants: KABUSHIKI KAISHA TOSHIBA, Tokyo (JP); TOSHIBA MEDICAL SYSTEMS CORPORATION, Otawara-shi (JP)

(72) Inventors: Kazuya OKAMOTO, Chuo Saitama Saitama (JP); Takashi KAWANO, Suruga Shizuoka Shizuoka (JP)

(21) Appl. No.: 14/689,241

(22) Filed: Apr. 17, 2015

Related U.S. Application Data
(63) Continuation of application No. PCT/JP2013/077344, filed on Oct. 8, 2013.

(30) Foreign Application Priority Data
Oct. 17, 2012 (JP) 2012-230027

(51) Int. Cl. G08B 5/36

(52) U.S. Cl. CPC G08B 5/36

(57) ABSTRACT

According to one embodiment, a discrimination object includes a display part and an attaching part. The display part is configured to display whether a target is permitted to be brought in a magnetic resonance imaging room. The attaching part is configured to attach the display part with the target on which whether the target is permitted to be brought in the magnetic resonance imaging room should be displayed. The attaching part has a tubular structure in a state where the attaching part has been attached with the target.

### CROSS REFERENCES TO RELATED APPLICATIONS

This is a continuation of Application PCT/JP2013/77344, filed on Oct. 8, 2013.

This application is based upon and claims the benefit of priority from Japanese Patent Application No. 2012-230027, filed on Oct. 17, 2012; the entire contents of which are incorporated herein by reference.

### FIELD

Embodiments described herein relate generally to a discrimination object and a medical device.

### BACKGROUND

The MRI (Magnetic Resonance Imaging) apparatus is an imaging diagnostic apparatus which magnetically excites nuclear spins of an object set in a static magnetic field with RF (radio frequency) signals having the Larmor frequency and reconstructs an image based on NMR (nuclear magnetic resonance) signals generated due to the excitation.

The magnetic field strengths of MRI apparatuses tend to be increased. For this reason, the risk of an attraction accident of a ferromagnetic body by bringing the ferromagnetic body close to an MRI apparatus has also increased. Therefore, it is important to pay further attention so that medical devices and medical equipments including magnetic material may not be brought into an MRI room. If an equipment or a device including a ferromagnetic body is brought into an area near an MRI apparatus, the equipment or the device is attracted to the static field magnet by the strong magnetic force. Consequently, the equipment or the device may result in its damage. Furthermore, a patient may be harmed.

Accordingly, an equipment consisting of nonmagnetic material and an equipment using an ignorable amount of magnetic material so that they can be brought into an MRI room are on the market in recent years. However, equipments and devices made by special specifications to be brought into an MRI room are generally expensive. Moreover, equipments and devices consisting of materials which can be brought into an MRI room occupy only a part of many equipments and devices actually used in medical institutions.

For this reason, the risk that an equipment or a device possibly causing an attraction accident is accidentally brought into an MRI room still remains, and attraction accidents have actually arisen. Accordingly, the method of installing an apparatus, which electrically detects magnetic material, at an entrance of an MRI room has been tried.

### PRIOR TECHNICAL LITERATURE

[Patent literature 1] JPA 2007-289670

[Patent literature 1] JPA 2011-62434

However, an apparatus which detects pass of a magnetic body is expensive. Moreover, it is difficult to detect all magnetic bodies having various sizes.

Accordingly, an object of the present invention is to easily obviate an attraction accident to a static field magnet in an MRI room.

### BRIEF DESCRIPTION OF THE DRAWINGS

In the accompanying drawings:

FIG. 1 is an oblique view showing a structure of a discrimination object according to the first embodiment of the present invention;

FIG. 2 is a side view of the discrimination object shown in FIG. 1;

FIG. 3 shows an example of medical device including the discrimination object shown in FIG. 1 as an element;

FIG. 4 is an oblique view showing a structure of a discrimination object for an MRI room according to the second embodiment of the present invention;

FIG. 5 shows a different example of method for displaying letters on the display part shown in FIG. 4;

FIG. 6 is a structural view of a discrimination object for an MRI room according to the third embodiment of the present invention;

FIG. 7 is a structural view of a discrimination object for an MRI room according to the fourth embodiment of the present invention; and

FIG. 8 is a structural view of a discrimination object for an MRI room according to the fifth embodiment of the present invention.

### DETAILED DESCRIPTION

In general, according to one embodiment, a discrimination object includes a display part and an attaching part. The display part is configured to display whether a target is permitted to be brought in a magnetic resonance imaging room. The attaching part is configured to attach the display part with the target on which whether the target is permitted to be brought in the magnetic resonance imaging room should be displayed. The attaching part has a tubular structure in a state where the attaching part has been attached with the target.

Further, according to another embodiment, a discrimination object includes a display part and an attaching part. The display part is configured to display whether a target is permitted to be brought in a magnetic resonance imaging room. The attaching part is configured to attach the display part with the target on which whether the target is permitted to be brought in the magnetic resonance imaging room should be displayed. At least a part of the attaching part consists of an elastic material.

Further, according to another embodiment, a medical device includes the discrimination object and a main body with which the discrimination object is attached.

Further, according to another embodiment, a medical device, having a bar and a wheel, includes a display part and an attaching part for attaching the display part with the bar. The display part is configured to display whether the medical device is permitted to be brought in a magnetic resonance imaging room.

A discrimination object and a medical device according to embodiments of the present invention will be described with reference to the accompanying drawings.

### The First Embodiment

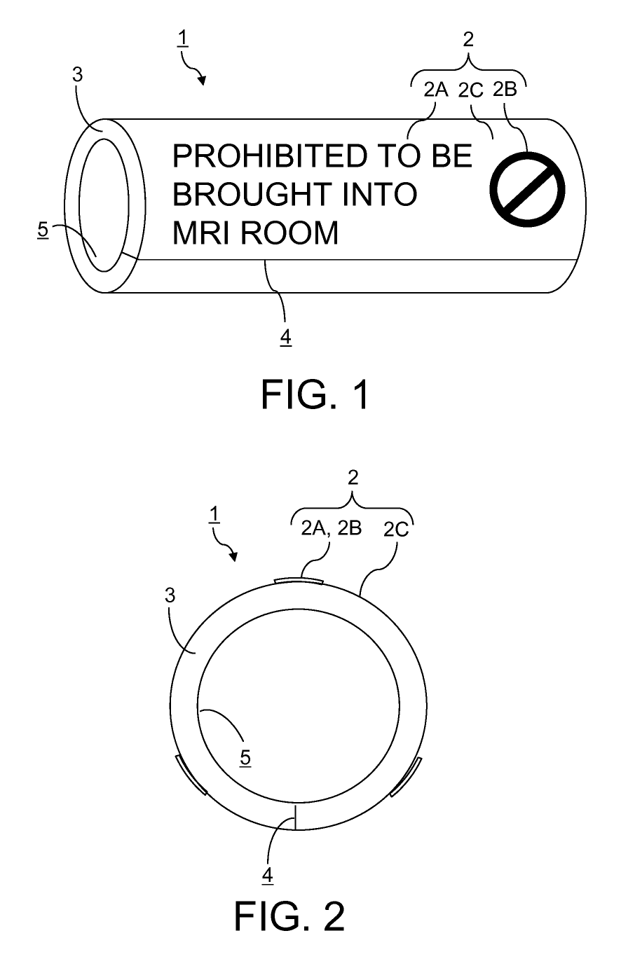

FIG. 1 is an oblique view showing a structure of a discrimination object according to the first embodiment of the present invention, and FIG. 2 is a side view of the discrimination object shown in FIG. 1.

A discrimination object 1 is to display whether it is permitted or not to be brought into an MRI room, on each of various equipments and devices used in a medical institution. For that purpose, the discrimination object 1 has a display part 2 and an attaching part 3. The display part 2 is the part for displaying whether it is permitted to be brought into an MRI room or not. On the other hand, the attaching part 3 is the part for attaching the display part 2 to a target on which whether it is permitted to be brought into an MRI room or not should be displayed.

In the illustrated example, the attaching part 3 has a cylindrical structure. Then, the outside surface of the cylindrical structure is the display part 2. Moreover, the attaching part 3 has a slit 4 in the length direction. Therefore, each bar-shaped part and each cable of equipments and devices used in a medical institution can be inserted inside the attaching part 3 through the slit 4. In this case, the attaching part 3 becomes a cylindrical structure in the condition that the attaching part 3 has been attached to a target on which whether it is permitted to be brought into an MRI room or not should be displayed.

Especially, it is preferred to make at least a part of the attaching part 3 using an elastic body. In the illustrated example, the whole attaching part 3 consists of a cylindrical rubber having the slit 4. For this reason, the attaching part 3 deforms flexibly. Therefore, the discrimination object 1 can fit an attaching portion of a target equipment or device.

Moreover, the cylindrical attaching part 3 consisting of the rubber has the slit 4 approximately parallel to the cylindrical axis, in the illustrated example. Therefore, the attaching part 3 can be unfolded from the slit 4 into a two dimensional sheet. For this reason, it is possible to easily attach the attaching part 3 to each of equipments and devices which have various forms and structures.

Furthermore, the elastic force of the attaching part 3 at least partly consisting of the elastic material can prevent the attaching part 3 from a slippage from an attached part of a target equipment or device. Note that, an antiskid surface may be formed on the part of the attaching part 3 which contacts with a target equipment or device. For example, the surface roughness inside the cylindrical attaching part 3 can be rougher than the surface roughness of the part, such as the outside surface, influencing its appearance. In this case, the inside surface of the attaching part 3 functions as a stopper face 5 which prevents the discrimination object 1 from a slippage.

Examples of the elastic material include a resin, such as a plastic, having elastic force as well as a rubber. When the attaching part 3 consists of a plastic, it is practical to widen the width of the slit 4 formed in the attaching part 3 so that the cross section of the attaching part 3 becomes a C shape. This enables the attaching part 3 to be attached to an equipment or a device by pushing the slit 4, formed in the axis direction of the cylindrical attaching part 3, to a bar-shaped part of the equipment or the device, to open the slit 4.

On the other hand, the display part 2 is the part which displays whether it is permitted to be brought into an MRI room or not, using at least one of lights, colors, letters, and signs. In the illustrated example, the display part 2 displays that bringing a target equipment or device into an MRI room is not permitted, using letters 2A, signs 2B, and a color 2C.

Besides the illustrated example, at least one of a light reflecting plate, a luminous object, and a fluorescent body can be also used as at last a part of the display part 2. In this case, whether it is permitted to be brought into an MRI room or not can be displayed using a light. Especially, when a fluorescent part is formed by applying a fluorescent paint, the elasticity and the flexibility of the attaching part 3 can be kept.

The contents displayed on the display part 2 may be not only contents directly displaying whether it is permitted to be brought into an MRI room or not, as illustrated, but contents indirectly displaying that. For example, the display part 2 may display whether an attached target is a magnetic body or a nonmagnetic body.

As illustrated, the letters 2A and the signs 2B can be displayed on plural positions so as to be recognized from plural directions. Moreover, using the color 2C together allows an easy check of whether it is permitted to be brought into an MRI room or not. That is, the discrimination object 1 can be used as a color marker. An inside of a medical institution, such as a hospital or a clinic, is generally bright. Therefore, it is preferred to use a color, deeper than a typical color used outdoors, for the discrimination object 1. Moreover, the discrimination object 1 may be colored using a fluorescent paint.

The display part 2 can display not only the indication of prohibition for bringing a target into an MRI room but also the indication of permission for bringing a target into an MRI room or for using a target in an MRI room. For a specific example, three kinds of displays as “Prohibited to be brought into MRI room”, “Pay attention when brought into MRI room”, and “Permitted to be brought into MRI room” can be prepared. Moreover, the background colors used for the display parts 2, displaying “Prohibited to be brought into MRI room”, “Pay attention when brought into MRI room”, and “Permitted to be brought into MRI room” can be red, yellow, and green respectively for color discrimination.

The targets to be prohibited to be brought into an MRI room are equipments and devices having the risk of attraction accidents. Therefore, the targets to be prohibited to be brought into an MRI room are equipments and devices each including magnetic material or ferromagnetic material whose amount is not negligible. Specific examples include a movable bed, an intravenous drip stand, a gas cylinder, a cylinder holder, a walking aid, a stretcher, a cleaning equipment, an industrial tool, a chair, and a wheelchair, which are ironware placed around an MRI room and objects each consisting of ferromagnetic material as main component. Especially, an intravenous drip stand including ferromagnetic material has the highest risk of an attraction accident.

On the other hand, the targets which can be used in an MRI room are mainly products consisting of nonmagnetic material. Moreover, equipments and devices made in special specifications so as to be able to be brought into an MRI room are also included in the targets which can be brought and used in an MRI room. A wheelchair and an intravenous drip stand designed to be able to be brought into an MRI room are highly practical examples.

Moreover, a pulse oximeter and a sphygmomanometer are products which can be brought and used in an MRI room while require attentions. Then, the discrimination object 1 on which “Pay attention when brought into MRI room” is displayed on the display part 2 can be prepared for these products.

Making the display part 2 and the attaching part 3 themselves by nonmagnetic materials leads to prevention of attraction accidents. However, a part of the display part 2 or the attaching part 3 may be made by a magnetic material as long as the amount of the magnetic material is negligible. For example, a part of the display part 2 may be composed by a light reflecting plate and/or a luminous body including a magnetic material.

Each target with which the discrimination object 1 is attached is an equipment or a device, which may be brought into an MRI room, as mentioned above. Therefore, the attaching part 3 has a structure which can attach the display part 2 to at least one of a movable bed, an intravenous drip stand, a gas cylinder, a cylinder holder, a walking aid, a stretcher, a cleaning equipment, an industrial tool, a chair, and a wheelchair.

Moreover, the discrimination object 1 can be also used as an element of a medical device. In that case, the medical device is composed by the discrimination object 1 and a main body with which the discrimination object 1 is attached. Examples of the main part include a movable bed for setting a patient, an intravenous drip stand, a gas cylinder, such as an oxygen cylinder, a walking aid, a stretcher, and a wheelchair. Especially, when a medical device has been designed with special specifications so as to be able to be brought into an MRI room, the fact that the main part is guaranteed to be able to be brought into an MRI room may be displayed on the display part 2.

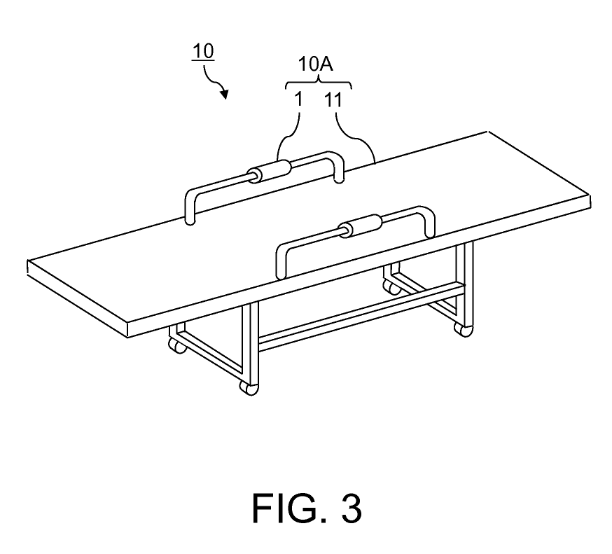

FIG. 3 shows an example of medical device including the discrimination object 1 shown in FIG. 1 as an element.

As the example shown in FIG. 3, the discrimination object 1 can be attached to a movable bed 10A as an example of the medical device 10. In the example shown in FIG. 3, the cylindrical discrimination objects 1 have been attached to the handrail parts of the movable bed 10A as the main part 11. Similarly, the discrimination object 1 can be attached to a typical medical device, such as a stretcher and a wheelchair, used in a medical institution. For example, a medical device having a pole body, such as a grip or a supporting post, and wheels can have the display part 2 and the attaching part 3 as elements of the medical device. In this case, the display part 2 can be attached with the pole body by the attaching part 3.

The discrimination object 1 mentioned above is to display whether it is permitted to be brought into an MRI room or not, on an equipment or a device which may be brought into an MRI room, in a medical institution. Moreover, the medical device has the above mentioned discrimination object 1 as an element.

Using the discrimination object 1 can prevent an equipment or a device, which should not be brought into an MRI room, from being actually brought into an MRI room. Consequently, attraction accidents caused by a magnetic field in an MRI room can be prevented beforehand. On the contrary, workers can easily recognize permission to bring equipments and devices, which can be brought into an MRI room, into an MRI room.

### The Second Embodiment

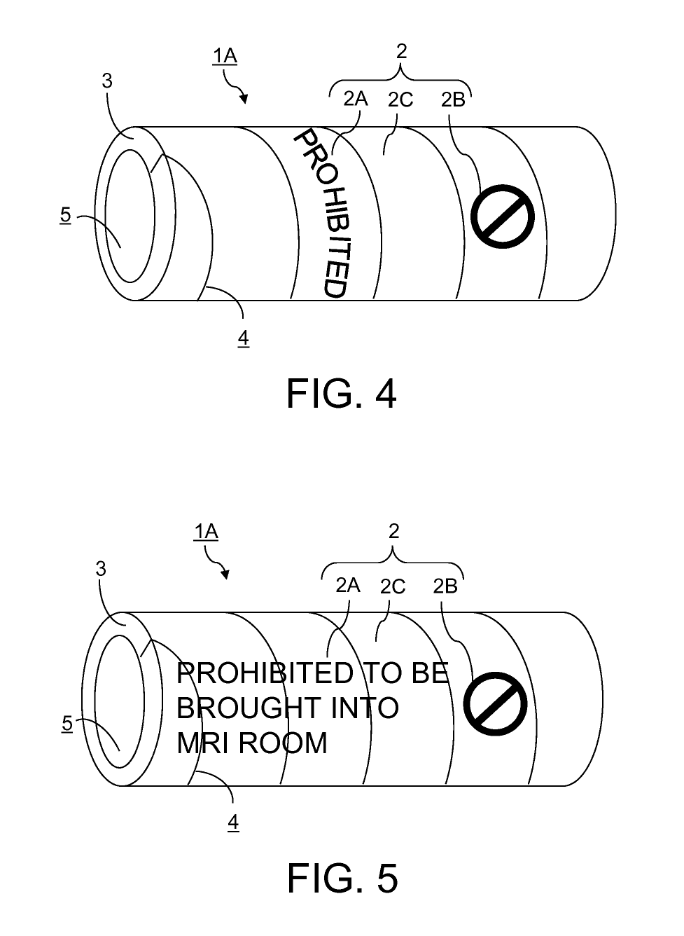

FIG. 4 is an oblique view showing a structure of a discrimination object for an MRI room according to the second embodiment of the present invention. FIG. 5 shows a different example of method for displaying letters on the display part shown in FIG. 4.

A discrimination object 1A of the second embodiment shown in FIG. 4 differs from the discrimination object 1 of the first embodiment shown in FIG. 1 in the direction of the slit 4 formed in the attaching part 3. Other configurations and functions do not substantially differ from those of the discrimination object 1 of the first embodiment shown in FIG. 1. Therefore, the same signs are attached to the same elements and the explanations thereof are omitted.

The discrimination object 1A has a spiral slit 4 on the cylindrical attaching part 3. For this reason, the attaching part 3 unfolded along the slit 4 has a string shape. The discrimination object 1A having such a structure can be easily attached to even a curved bar part. For a specific example, the discrimination object 1A can be wound around a curved shaft of a push handle part included in a wheelchair.

When a target with which the discrimination object 1A is attached has been almost specified, the letters 2A and the signs 2B displayed on the display part 2 may be completed as the result of attaching the attaching part 3 to the target as shown in FIG. 5. In this case, the visibility of the letters 2A and the signs 2B can be improved. On the other hand, when the letters 2A and the signs 2B of the display part 2 can be read even in the state that the attaching part 3 is unfolded, as shown in FIG. 4, the discrimination objects 1A can be attached to targets having various forms. In addition, it is possible to adjust the length of the discrimination object 1A according to a length of an attaching target.

### The Third Embodiment

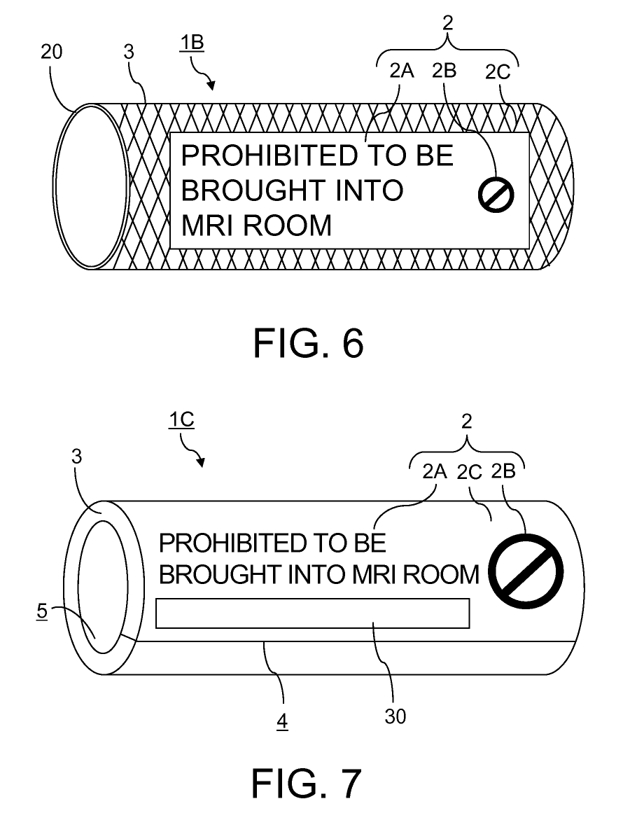

FIG. 6 is a structural view of a discrimination object for an MRI room according to the third embodiment of the present invention.

A discrimination object 1B of the third embodiment shown in FIG. 6 differs from the discrimination object 1 of the first embodiment shown in FIG. 1 in the structure of the attaching part 3. Other configurations and functions do not substantially differ from those of the discrimination object 1 of the first embodiment shown in FIG. 1. Therefore, the same signs are attached to the same elements and the explanations thereof are omitted.

The discrimination object 1B has an attaching part 3 having a net-like structure. Therefore, the attaching part 3, consisting of an elastic material such as a resin, becomes an expandable and contractable net. Meanwhile, the attaching part 3, consisting of a flexible nonmagnetic material such as a resin, even without elasticity, can be used as a storage net which can store an object inside and allows checking the stored object. For this reason, the discrimination object 1B can be attached to even a target which is not a bar shaped part or a cable. Alternatively, an attaching target can be covered by the discrimination object 1B. For a practical example, the discrimination object 1B can be attached to an oxygen cylinder as a net shaped marker.

In the illustrated example, the attaching part 3 has a cylindrical and net-like structure. Therefore, it is preferred to install ring shaped members 20, for reinforcing the attaching part 3, at the both open end parts. Surely, the attaching part 3 may have a bag shaped structure having a single opening.

Note that, the display part 2 to display the letters 2A and the signs 2B can be made by a flexible or elastic nonmagnetic sheet, such as a resin, as illustrated. However, the letters 2A and the signs 2B may be printed directly on string fibers making the net of the attaching part 3. In that case, the letters 2A and the signs 2B are to be recognized by the interpolation effect in the human visual sense.

### The Fourth Embodiment

FIG. 7 is a structural view of a discrimination object for an MRI room according to the fourth embodiment of the present invention.

A discrimination object 1C of the fourth embodiment shown in FIG. 7 differs from the discrimination object 1 of the first embodiment shown in FIG. 1 in the point that a magnetic body 30 is mounted. Other configurations and functions do not substantially differ from those of the discrimination object 1 of the first embodiment shown in FIG. 1. Therefore, the same signs are attached to the same elements and the explanations thereof are omitted.

The discrimination object 1C has the magnetic body 30 purposely. However, the magnetic body 30 is installed only on the discrimination object 1C of which the display part 2 displays that bringing a target into an MRI room is not permitted. The install position of the magnetic body 30 is arbitrary. In the illustrated example, the magnetic body 30 has been installed on the outside surface of the cylindrical attaching part 3.

When the magnetic body 30 is installed on the discrimination object 1C as described above, the magnetic body 30 is detected by a detection unit for magnetic material placed at an entrance of MRI room. For this reason, an alarm by the detection unit can also prevent a dangerous object from being brought into the MRI room in addition to the display by the discrimination object 1C.

Therefore, the magnetic body 30 has an amount unfailingly detectable by a detection unit. On the contrary, it is desired that an amount of the magnetic body 30 is small from a viewpoint of the attraction accident prevention as long as the amount can be detected by a detection unit. Thus, the discrimination object 1C can include the magnetic body 30 to have a detection unit detect that an attaching target is not permitted to be brought into an MRI room.

### The Fifth Embodiment

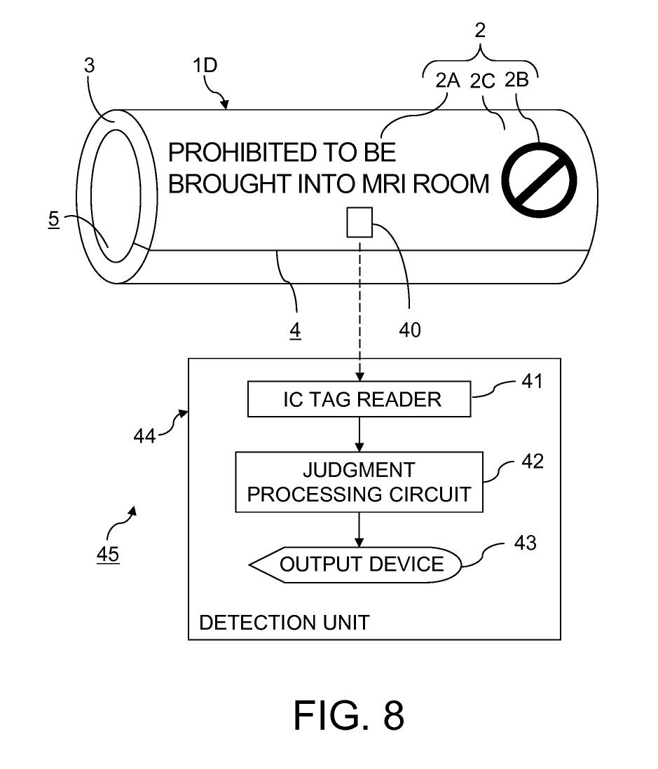

FIG. 8 is a structural view of a discrimination object for an MRI room according to the fifth embodiment of the present invention.

A discrimination object 1D of the fifth embodiment shown in FIG. 8 differs from the discrimination object 1 of the first embodiment shown in FIG. 1 in the point that an IC (Integrated Circuit) tag 40 is mounted. Other configurations and functions do not substantially differ from those of the discrimination object 1 of the first embodiment shown in FIG. 1. Therefore, the same signs are attached to the same elements and the explanations thereof are omitted.

The discrimination object 1D has the IC tag 40. The IC tag 40 can store the information indicating whether an attaching target of the discrimination object 1D is permitted to be brought into an MRI room or not. The install position of the IC tag 40 is arbitrary. In the illustrated example, the IC tag 40 has been installed on the outside surface of the cylindrical attaching part 3.

When the discrimination object 1D has the IC tag 40, a detection unit 44 including an IC tag reader 41, a judgment processing circuit 42, and an output device 43, such as a display, a speaker or a lamp, can determine whether an attaching target of the discrimination object 1D is permitted to be brought into an MRI room or not.

Note that, the judgment processing circuit 42 has a function to judge whether a target with which the IC tag 40 has been attached is permitted to be brought into an MRI room or not, based on the information detected by the IC tag reader 41, and a function to output the judgment result from the output device 43 with an arbitrary method, such as an alarm, a voice, or a light. The judgment processing circuit 42 having these functions can be configured by circuits and/or a computer reading programs. That is, the judgment processing circuit 42 can be configured by a processing circuitry consisting of a single circuit or plural circuits. The processing circuitry may be at least one CPU (central processing unit), at least one GPU (graphics processing unit), at least one ASIC (application specific integrated circuit), and/or at least one PLD (programmable logic device), such as an SPLD (simple PLD), a CPLD (complex PLD) and an FPGA (field programmable gate array).

For this reason, when the detection unit 44 is installed around an entrance of MRI room, the judgment processing and the alarm by the detection unit 44 can also prevent a dangerous object from being brought into the MRI room, in addition to the display by the discrimination object 1D.

Thus, the discrimination object 1D can have the IC tag 40 so that the detection unit 44 can detect that an attaching target is not permitted to be brought into an MRI room. Surely, the IC tag 40 may be installed so that the detection unit 44 can detect that an attaching target is permitted to be brought into an MRI room. Furthermore, a discrimination system 45 which judges whether a target with which the discrimination object 1D has been attached is permitted to be brought into an MRI room or not may be composed by the discrimination object 1D and the detection unit 44.

### Other Embodiments

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

For example, a discrimination object may be composed by the display part 2 consisting of a flat plate or sheet and the attaching part 3 consisting of a suspending device or a sealant material such as an adhesive though the attaching part 3 and the display part 2 which have a cylindrical structure have been mainly exemplified in each embodiment mentioned above. When a discrimination object is designed to have a cylindrical structure, it may be configured to be opened and closed with a hook and loop fastener or a line fastener to be attached to a target.

Moreover, a shape-memory resin may be used as a material of the attaching part besides an elastic material. The shape memory resin can be deformed like a rubber when it is heated while the shape memory resin becomes hard and its form is fixed at normal temperature. Alternatively, the shape memory resin occasionally means a resin having the behavior that it recovers its original shape by heating even if it is deformed at a certain temperature after its forming.

Therefore, when at least a part of the attaching part having a cylindrical structure or a net structure is made by a shape memory resin which cures at normal temperature, it is possible to easily make a discrimination object which can fit a shape of an attaching target.

Moreover, the features of the discrimination objects 1, 1A, 1B, 1C, and 1D of the respective embodiments may be combined with each other. Therefore, a discrimination object may have at least one of the magnetic body 30 and the IC tag 40 so that a detection unit can detect that an attaching target of the discrimination object is not permitted to be brought into an MRI room.

What is claimed is:

1. A discrimination object comprising:
a display part configured to display whether a target is permitted to be brought in a magnetic resonance imaging room; and
an attaching part configured to attach said display part with the target on which whether the target is permitted to be brought in the magnetic resonance imaging room should be displayed,
wherein said attaching part has a tubular structure in a state where said attaching part has been attached with the target.

2. A discrimination object comprising:
a display part configured to display whether a target is permitted to be brought in a magnetic resonance imaging room; and
an attaching part configured to attach said display part with the target on which whether the target is permitted to be brought in the magnetic resonance imaging room should be displayed,
wherein at least a part of said attaching part consists of an elastic material.

3. A discrimination object of claim 2,
wherein said attaching part has a slit.

4. A discrimination object of claim 3,
wherein said attaching part has a slit in a length direction of said attaching part or a helical slit.

5. A discrimination object of claim 1,
wherein said attaching part has a mesh or net structure.

6. A discrimination object of claim 2,
wherein the elastic material is a rubber.

7. A discrimination object of claim 1,
wherein at least a part of said attaching part consists of a shape-memory resin.

8. A discrimination object of claim 1,
wherein said display part is configured to display whether the target is permitted to be brought in the magnetic resonance imaging room, using at least one of a light, a color, a letter, and a sign.

9. A discrimination object of claim 1,
wherein at least a part of said display part consists of at least one of a light reflecting plate, an illuminant material, and a fluorescent material.

10. A discrimination object of claim 1,
further comprising: at least one of a magnetic material and an integrated circuit tag for detecting that the target is not permitted to be brought in the magnetic resonance imaging room, by a detection unit.

11. A discrimination object of claim 1,
wherein said display part is configured to display whether the target is a magnetic material or a nonmagnetic material.

12. A discrimination object of claim 1,
wherein said attaching part has an antiskid surface on a part contacting with the target.

13. A discrimination object of claim 1,
wherein said attaching part has a structure which can attach said display part with at least one of a movable bed, an intravenous drip stand, a gas cylinder, a cylinder holder, a walking aid, a stretcher, a cleaning equipment, an industrial tool, a chair, and a wheelchair.

14. A discrimination object of claim 1,
wherein each of said display part and said attaching part consists of a nonmagnetic material.

15. A medical device comprising:
a discrimination object of claim 1; and
a main body with which said discrimination object is attached.

16. A medical device of claim 15,
wherein said main body is a movable bed, an intravenous drip stand, a gas cylinder, a cylinder holder, a walking aid, a stretcher, or a wheelchair.

17. A medical device of claim 15,
wherein said display part is configured to display that said main body is guaranteed to be allowed to be brought in the magnetic resonance imaging room.

18. A medical device, having a bar and a wheel, comprising:
a display part configured to display whether said medical device is permitted to be brought in a magnetic resonance imaging room; and
an attaching part for attaching said display part with said bar.
